(19) United States
(12) Patent Application Publication
(10) Pub. No.: US 2004/0151820 A1
(43) Pub. Date: Aug. 5, 2004

(54) Shaped cheese singles

(76) Inventor: Richard Harris, Manchester, MI (US)

Correspondence Address: John G. Posa, Gifford, Krass, Groh, Sprinkle,, Anderson & Citkowski, P.C., 280 N. Old Woodward Ave., Suite 400, Birmingham, MI, 48009-5394, US

(21) Appl. No.: 10/748,322

(22) Filed: Dec. 30, 2003

Related U.S. Application Data
(60) Provisional application No. 60/438,042, filed on Jan. 3, 2003.

(51) Int. Cl. A23C 19/00

(52) U.S. Cl. 426/582

(57) ABSTRACT

Cheese slices have corresponding to food items or other applications. The preferred embodiment is associated with food-conformal cheese singles, comprising individually sliced pieces of cheese, each having an outer shape corresponding to a round hamburger or elongated hot dog, and separation sheets between the individually sliced pieces of cheese. For hamburgers, the outer shape may be a circle having a diameter on the order of 2″ to 5″. For hotdogs, the food-conformal cheese may have an outer shape in the form of an elongated rectangle measuring, for example, ¾″ to 4½ inches or thereabouts. The corners of the rectangle may be sharp or rounded. The invention is not limited to food-shaped cheese, and many include other shapes, without or without interleaving sheets. Cut-outs may be used, and in cases where coloration is present, this may be provided with food coloring or different cheeses.

### REFERENCE TO RELATED APPLICATION

This application claims priority from U.S. Provisional Application Serial No. 60/438,042, filed Jan. 3, 2003, the entire content of which is incorporated herein by reference.

### FIELD OF THE INVENTION

This invention relates generally to cheese and, in particular, to cheese having a shape that conforms to food items or other applications.

### BACKGROUND OF THE INVENTION

Barbeque grilling has become increasingly popular, and cheeseburgers are often the food item grilled. For the sake of convenience, the cheese is applied in the form of “singles” wherein each slice is separated from the other slices by a larger thin layer of wax paper, plastic, or the like. Using this approach, a piece of cheese may be placed onto a burger when ready, with the separating layer then removed, a process which is very convenient when numerous burgers must be cheese-coated, as might be the case during a large outdoor barbeque.

As is well known, hand-made as well as some prepackaged hamburgers are round, whereas cheese singles are square. This leads to a situation shown generally at 100 in FIG. 1, wherein, when a round hamburger 102 is covered with a square piece of cheese 104, the corners of the cheese can drip down off the side of the burger and onto the grill members 112, creating a situation that requires grill cleaning. Anyone who owns an outdoor barbeque grill knows the frustrating task of removing such substance from the grill, especially burned cheese which is often difficult to remove.

### SUMMARY OF THE INVENTION

This invention improves upon the existing art by providing cheese slices having a shape that conforms to food items or other applications. The preferred embodiment is associated with food-conformal cheese singles, comprising individually sliced pieces of cheese, each having an outer shape corresponding to a round hamburger or elongated hot dog, and separation sheets between the individually sliced pieces of cheese.

For hamburgers, the outer shape may be a circle having a diameter on the order of 2″ to 5″. For hotdogs, the food-conformal cheese may have an outer shape in the form of an elongated rectangle measuring, for example, ¾″ to 4½ inches or thereabouts. The corners of the rectangle may be sharp or rounded.

The invention is not limited to food-shaped cheese, and many include other shapes, without or without interleaving sheets. For example, alternative embodiments include animal-shaped piece of cheese; cheese having a face associated therewith; sports-related cheese; geometrically-shaped cheese and cheese with a cartoon character. Cut-outs may be used, and in cases where coloration is present, this may be provided with food coloring or different cheeses.

### BRIEF DESCRIPTION OF THE DRAWINGS

FIG. 1 illustrates a situation when a round hamburger is covered with a square piece of cheese, causing the corners of the cheese to drip down off the side of the burger and onto a grill requiring cleaning;

FIG. 2 illustrates a round cheese single separated by interleaving sheets according to the invention;

FIG. 3 shows an elongated piece of cheese adapted for use with hot dogs;

FIG. 4 shows an animal-shaped piece of cheese according to the invention;

FIG. 5 shows a piece of cheese according to the invention having a face associated therewith;

FIG. 6 shows sports-related piece of cheese according to the invention;

FIG. 7 shows geometrically-shaped piece of cheese according to the invention; and

FIG. 8 shows a piece of cheese according to the invention with a cartoon character.

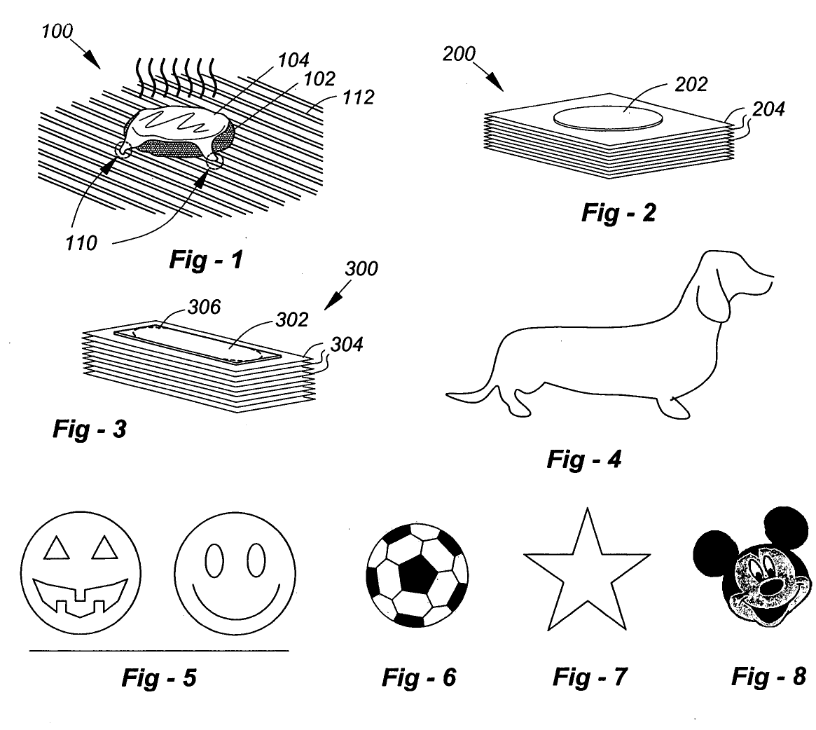

### DETAILED DESCRIPTION OF THE INVENTION

According to this invention, cheese is provided in a form more suitable to certain types of food, such as hamburgers and hot dogs. One preferred is shown generally at 200 in FIG. 2, wherein round cheese 202 is provided as singles, each single being separated by interleaving sheets 204. The cheese 202 preferably has a diameter on the order of 3 inches, or thereabouts, but may be somewhat larger or smaller in diameter, depending upon compatibility with prepackaged meat patties, thickness, type of cheese, and other factors. The invention is not limited in terms of thickness or type of cheese, however, and may include cheddar, Swiss, muenster and so forth. Nor are the sheets 204 limited in terms of material or shape, and may be plastic, wax paper, and the like, and though shown as being square for the ease of convenience, such sheets may be round, for example.

In a different preferred embodiment of the invention, cheese singles shown generally at 300 in FIG. 3, take the form of elongated pieces adapted for use with hot dogs. In this case, each piece 302 measures approximately 3/4 inch×4½ inches, or thereabouts, and although square corners are shown, the corners may be rounded as shown by the broken line of 306. Again, size and thickness of the cheese 302 may vary so as to conform to different types of hot dogs, bratwurst, and so forth, and the sheets 304 may be made of any material as discussed above.

The invention is not limited to food-shaped cheese, and many include other shapes, without or without interleaving sheets. For example, FIG. 4 shows an animal-shaped piece of cheese according to the invention; FIG. 5 shows a piece of cheese according to the invention having a face associated therewith; FIG. 6 shows sports-related piece of cheese according to the invention; FIG. 7 shows geometrically-shaped piece of cheese according to the invention; and FIG. 8 shows a piece of cheese according to the invention with a cartoon character. In cases where coloration is present (i.e, FIGS. 6 and 8), this may be provided with food coloring or different cheeses (i.e., swiss plus cheddar)

I claim:

1. Food conformal cheese singles, comprising:
individually sliced pieces of cheese, each having an outer shape corresponding to a round hamburger or elongated hot dog; and
separation sheets between the individually sliced pieces of cheese.

2. The food-conformal cheese of claim 1, wherein the outer shape is a circle.

3. The food-conformal cheese of claim 2, wherein the circle has a diameter on the order of 2″ to 5″.

4. The food-conformal cheese of claim 1, wherein the outer shape is an elongated rectangle.

5. The food-conformal cheese of claim 4, wherein the rectangle measures ¾″ to 4½ inches or thereabouts.

6. The food-conformal cheese of claim 4, wherein the corners of the rectangle are rounded.
